(19) United States
(12) Patent Application Publication
(10) Pub. No.: US 2025/0059998 A1
(43) Pub. Date: Feb. 20, 2025

(54) FASTENER

(71) Applicant: BEAR FASTENING SOLUTIONS INC., CHIAYI CITY (TW)

(72) Inventor: HUNG-JEN TSENG, KAOHSIUNG CITY (TW)

(21) Appl. No.: 18/403,284

(22) Filed: Jan. 3, 2024

(30) Foreign Application Priority Data
Aug. 15, 2023 (TW) 112208620

(51) Int. Cl. F16B 25/00

(52) U.S. Cl. CPC F16B 25/0068; F16B 25/0073; F16B 25/0084

(57) ABSTRACT

A fastener includes a head, a shank unit having a shank portion and a drilling portion with a tip, and a thread unit. The thread unit includes a first thread spirally disposed on the shank portion and includes a second thread and a third thread spiraling on the drilling portion respectively. The third thread is located between the first thread and the second thread. A first end of the third thread is connected to the first thread. A second end of the third thread can be connected to the tip. The second thread and the third thread cooperate to increase the cutting ability and efficiency, thereby reducing drilling resistance and attaining a quick screwing effect. The third thread connected to the first thread facilitates the removal of chips caused by cutting a workpiece, thereby preventing the workpiece from cracking and attaining an anti-loosening effect.

### BACKGROUND OF THE INVENTION

### 1. Field of the Invention

This invention relates to a screw structure and relates particularly to a fastener having a plurality of threads with different spiraling arrangements.

### 2. Description of the Related Art

Generally, a conventional screw includes a head, a shank extending outwards from the shank, and a threaded portion spiraling on the shank. In use, the threaded portion serves to cut a workpiece and drive the shank into the workpiece gradually. When the head touches a surface of the workpiece, a screwing operation of the screw is finished. However, the shank may get entangled in the uncut fibers of the workpiece easily, and threads of the threaded portion may be in very close contact with the workpiece during the drilling process. These phenomena cause larger resistance resisting the drilling process and thus decrease the drilling speed. The uncut fibers and debris generated by cutting the fibers may also be unduly accumulated among the threads and thus unable to be effectively removed, which causes the workpiece to crack easily. In this case, the screw may not be fastened in position. Therefore, a wood screw published by a Taiwanese patent application no. TW201137246A1 was disclosed. According to FIG. 2 of this published patent application, the wood screw 200 includes a head 210, a shank 220, a first thread 240, at lease one second thread 250, and a third thread 230. The first thread 240 and the second thread 250 are formed on a tapered portion 222 of the shank 220. The third thread 230 is formed on a parallel shank portion 224. The first thread 240, the second thread 250 and the third thread 230 do not connect with each other. The second thread 250 has a maximum guidance angle θ2. Accordingly, the threads are used to drill into a wood by cutting wood fibers and engage with the interior of the wood. When the head lies flush with the surface of the wood, the drilling operation is finished. However, because the threads are not connected to each other, debris and uncut fibers may be easily accumulated among the threads. In this case, the debris cannot be quickly removed, and an extremely large squeezing force may be exerted on an area between the shank and the wood, which leads to an increase in the drilling resistance, a decrease in the drilling speed, and even a cracking problem of the wood. Therefore, the screw still needs to be improved.

### SUMMARY OF THE INVENTION

An object of this invention is to provide a fastener capable of decreasing the drilling resistance by an increase in the cutting ability and efficiency, preventing the workpiece from cracking by an acceleration in the removal of chips, and attaining an anti-loosening effect.

A fastener of this invention is as defined in claim 1 and includes a head, a shank unit extending longitudinally from the head, and a thread unit spirally disposed on the shank unit. The shank unit defines a central axis and includes a drilling portion and a shank portion formed between the head and the drilling portion. The drilling portion has a tip located in opposing relationship to the head. The thread unit includes a first thread spirally disposed on an outer periphery of the shank portion and a second thread and a third thread spirally disposed on an outer periphery of the drilling portion, respectively. The third thread is located between the first thread and the second thread. The third thread has a first end facing the head and a second end opposite to the first end. The first end is connected to the first thread. In one preferred embodiment, the first thread, the second thread, and the third thread define a first path, a second path, and a third path while spirally winding around the shank unit, respectively. A first included angle defined between the central axis and the first path of the first thread can be greater than a third included angle defined between the central axis and the third path of the third thread, and the third included angle can be greater than a second included angle defined between the central axis and the second path of the second thread. In another preferred embodiment, the first end of the third thread is connected to the first thread, and the second end thereof is connected to the tip of the drilling portion. A fourth included angle is defined between the first path of the first thread and a horizontal reference line which is perpendicular to the central axis. A sixth included angle defined between the horizontal reference line and the third path of the third thread can be greater than the fourth included angle.

In accordance with the above configuration, the spiral arrangements of the second thread and the third thread cut fibers of a workpiece during a drilling process, which drives the shank unit into the workpiece quickly. The connection between the third thread and the first thread allows chips caused by cutting the workpiece to travel from the third thread to the first thread and then go out of the head by following the first thread, thereby decreasing the drilling resistance, attaining a quick drilling action and a smooth removal of chips, and preventing the workpiece from cracking. Furthermore, the space between the thread unit and the workpiece can accommodate chips in moderation for increasing the combination between the fastener and the workpiece, thereby attaining an anti-loosening effect.

Preferably, the first thread includes a first upper surface facing the head, a first lower surface facing the tip, and a first thread angle defined between the first upper surface and the first lower surface. The second thread includes a second upper surface facing the head, a second lower surface facing the tip, and a second thread angle defined between the second upper surface and the second lower surface. The third thread includes a third upper surface facing the head, a third lower surface facing the tip, and a third thread angle defined between the third upper surface and the third lower surface. In one preferred embodiment, the first thread angle can be different from either one or both of the third thread angle and the second thread angle. Preferably, the first thread angle is smaller than the third thread angle and the second thread angle. It is also possible that the second thread angle is equal to the third thread angle.

Preferably, in one preferred embodiment, the second upper surface and the second lower surface converge at a peak which defines a peak reference line perpendicular to the central axis. A second upper thread angle defined between the second upper surface and the peak reference line can be equal to a second lower thread angle defined between the second lower surface and the peak reference line. Consequently, the second thread can be symmetrical.

Preferably, in one preferred embodiment, the third upper surface and the third lower surface converge at a crest which defines a crest reference line perpendicular to the central axis. A third upper thread angle defined between the third upper surface and the crest reference line can be different from a third lower thread angle defined between the third lower surface and the crest reference line. Consequently, the third thread can be asymmetrical.

The first thread includes a plurality of first threaded convolutions. In one preferred embodiment, a cutting unit can be formed on each of the first threaded convolutions. The first thread also defines an imaginary line which is defined by connecting respective cutting units of adjacent first threaded convolutions sequentially, and preferably the imaginary line is non-parallel to the central axis of the shank. Accordingly, the cutting units formed on the first threaded convolutions can assist the first thread in cutting, thereby attaining an auxiliary cutting effect.

Preferably, in one preferred embodiment, the second thread is connected to the tip so that the spirally-winding arrangement of the second thread starts from the tip. In another preferred embodiment, the first thread is connected to the tip so that the spirally-winding arrangement of the first thread starts from the tip.

### BRIEF DESCRIPTION OF THE DRAWINGS

FIG. 1 is a schematic view showing a first preferred embodiment of this invention;

FIG. 2 is a schematic view showing the operation of the first preferred embodiment of this invention;

FIG. 3 is a schematic view showing a second preferred embodiment of this invention;

FIG. 4 is a schematic view showing a third preferred embodiment of this invention;

FIG. 5 is a schematic view showing a fourth preferred embodiment of this invention;

FIG. 6 is a partial schematic view showing a variation of the fourth preferred embodiment;

FIG. 7 is a cross-sectional view showing an encircled portion F7 of FIG. 5;

FIG. 8 is a cross-sectional view showing an encircled portion F8 of FIG. 5;

FIG. 9 is a cross-sectional view showing an encircled portion F9 of FIG. 5;

FIG. 10 is a schematic view showing a fifth preferred embodiment of this invention wherein a cutting unit is in combination with the fastener shown in FIG. 1;

FIG. 11 is a schematic view showing the fifth preferred embodiment wherein the cutting unit is in combination with the fastener shown in FIG. 3;

FIG. 12 is a schematic view showing the fifth preferred embodiment wherein the cutting unit is in combination with the fastener shown in FIG. 4;

FIG. 13 is a schematic view showing the fifth preferred embodiment wherein the cutting unit is in combination with the fastener shown in FIG. 5; and

FIG. 14 is a partial schematic view showing the fifth preferred embodiment wherein the cutting unit is in combination with the fastener shown in FIG. 6.

### DETAILED DESCRIPTION OF THE PREFERRED EMBODIMENTS

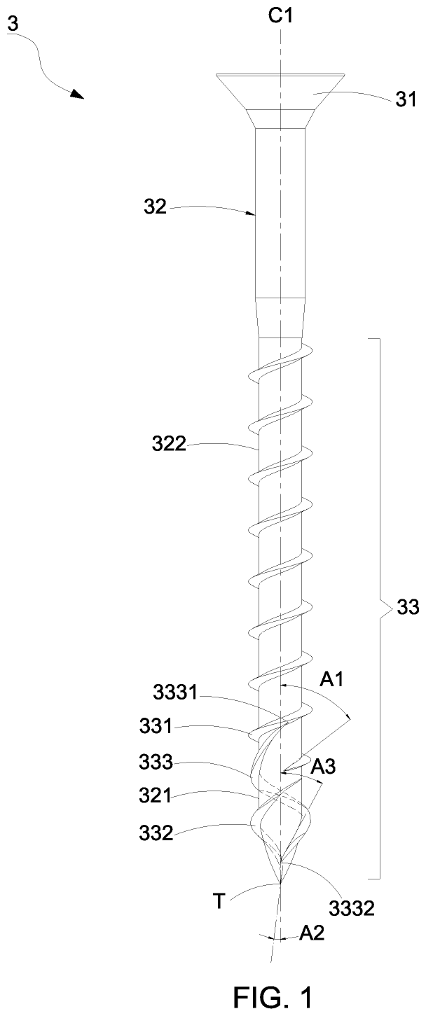

Referring to FIG. 1, a first preferred embodiment of the fastener 3 is shown. The fastener 3 includes a head 31, a shank unit 32 extending outwardly from the head 31, and a thread unit 33 spirally disposed on the shank unit 32. Explicitly, the shank unit 32 defines a central axis C1 and includes a drilling portion 321 and a shank portion 322 formed between the head 31 and the drilling portion 321. The drilling portion 321 is longitudinally extended by a length and provides a tip T located in opposing relationship to the head 31. The drilling portion 321 can be gradually reduced to become a tapering shape, preferably a conical shape, so that the tip T is in the form of a pointed tip.

The thread unit 33 is spirally disposed on the shank unit 32. Explicitly, the thread unit 33 includes a first thread 331, a second thread 332, and a third thread 333. The first thread 331 is primarily disposed on an outer periphery of the shank portion 322 in a spiral manner. The first thread 331 is spirally extended in the direction of the head 31 by a length, and accordingly a spiral angle is defined. In other words, the first thread 331 defines a first path while spirally winding around the shank portion 322, and a first included angle A1 is defined between the central axis C1 and the first path of the first thread 331. The second thread 332 is primarily disposed on an outer periphery of the drilling portion 321 in a spiral manner, and the third thread 332 is primarily disposed on the outer periphery of the drilling portion 321 in a spiral manner. Both of the second thread 332 and the third thread 333 are extended towards the head 31. Therefore, it is possible that the threads 332, 333 can be only located within the drilling portion 321 or can be further extended to the outer periphery of the shank portion 322. In addition, the second thread 332 and the third thread 333 define spiral angles, respectively. In other words, the second thread 332 defines a second path while spirally winding around the drilling portion 321, and the third thread 333 defines a third path while spirally winding around the drilling portion 321. A second included angle A2 is defined between the central axis C1 and the second path of the second thread 332, and a third included angle A3 is defined between the central axis C1 and the third path of the third thread 333.

Regarding the spiral arrangement of the second thread 332, the second thread 332 can be connected to or not connected to the tip T of the drilling portion 321. In the first preferred embodiment, it takes an example of a structure formed by connecting one end of the second thread 332 to the tip T so that the spirally-winding arrangement of the second thread 332, i.e. the second path, starts from the tip T. Another end of the second thread 332 can lie between the first thread 331 and the third thread 333. Furthermore, the third thread 333 is spirally disposed between the first thread 331 and the second thread 332. The third thread 333 has a first end 3331 and a second end 3332 opposite to the first end 3331. The first end 3331 is an end which faces the head 31. The first end 3331 is connected to the first thread 331. The second end 3332 can be connected to or not connected to the tip T. In the first preferred embodiment, it takes an example of a structure whose second end 3332 lies among the second thread 332, which causes the third thread 333 to be spirally extended from a place among the second thread 332 to the first thread 331.

Furthermore, the first included angle A1 of the first thread 331, the second included angle A2 of the second thread 332, and the third included angle A3 of the third thread 333 can be different from each other. For example, the first included angle A1 is greater than the third included angle A3, and the third included angle A3 is greater than the second included angle A2. Accordingly, the thread unit 33 has three threads with different spiral arrangements, as for example shown in FIG. 1. The operation of this invention will be described according to the first preferred embodiment.

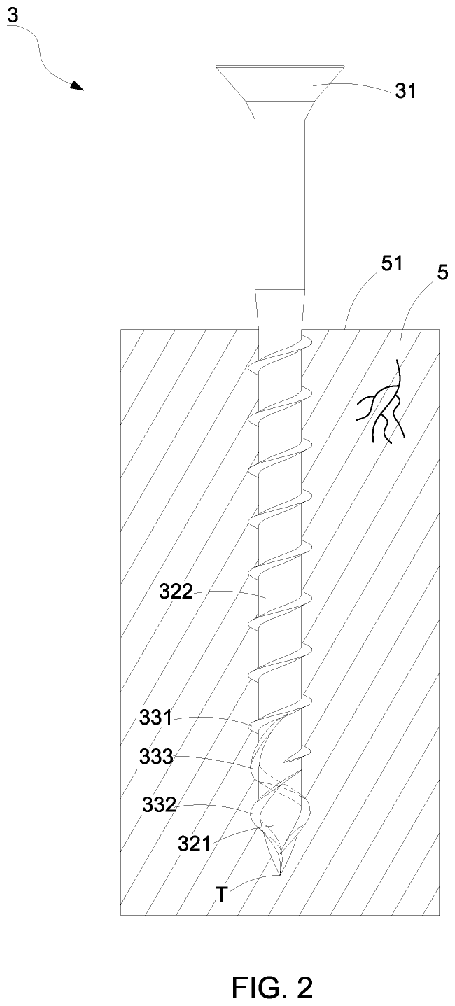

The operation of this invention is described with the aid of FIG. 1 and FIG. 2. In use, the drilling portion 321 is put against a surface 51 of the workpiece 5. Then, the head 31 is rotated, and the drilling portion 321 is driven to execute a screwing operation. The second thread 332 is in a steeper state because of the second included angle A2 when the second thread 332 is connected to the tip T. The coexistence of the above conditions allow the second thread 332 to cut fibers inside the workpiece 5 and conduct a drilling action at the beginning of the screwing operation. Meanwhile, the third thread 333 formed on the drilling portion 321 continues cutting the workpiece 5 while driving the second thread 332 into the workpiece 5. The cooperation between the second thread 332 and the third thread 333 increases the cutting ability and efficiency, thereby preventing the occurrence of uncut fibers, preventing the drilling portion 321 from getting entangled in the uncut fibers, and reducing the resistance against the drilling action. Consequently, the drilling portion 321 is quickly and smoothly drilled into the workpiece 5 without difficulty. When the third thread 333 enters the workpiece 5, the first thread 331 follows the third thread 333 and continues cutting the workpiece 5 so that the shank portion 322 is driven and quickly drilled into the workpiece 5, and the drilling resistance is also decreased. When the head 31 fits level with the surface 51 of the workpiece 5, the thread unit 33 is firmly engaged with an inner wall of the workpiece 5 to allow the fastener 3 to be screwed to the workpiece 5 in position. Consequently, the quick screwing operation of the fastener 3 is completed.

With respect to the drilling action, different spiral arrangements caused by the first thread 331, the second thread 332, and the third thread 333 cooperate with the third thread 333 formed between the second thread 332 and the first thread 331. Accordingly, chips caused by cutting the fibers of the workpiece 5 are pushed to the third thread 333 along a spiral track created by the second thread 332. Meanwhile, because the third thread 333 is connected to the first thread 331, the chips moves directly to the first thread 331 along a spiral track created by the third thread 333. Then, the chips moves towards the head 31 along a spiral track created by the first thread 331. Thereafter, some chips can be properly pushed out of the workpiece 5 so that a quick removal of chips is attained to prevent excessive chips from exerting undue pressure on the interior of the workpiece 5 and decrease the drilling resistance. Therefore, the workpiece 5 does not crack easily. The accumulation of excessive chips between the threads 331, 332, 333 of the thread unit 33 can also be prevented, with the result that remaining chips can be properly stored in the space between the shank unit 32 and the workpiece 5 to allow the fastener 3 to be firmly fastened in position. Thus, the combination between the fastener 3 and the workpiece 5 is increased. At this moment, the fastener 3 does not move away from the workpiece 5 automatically if the fastener 3 is subjected to external force or vibration, thereby attaining an anti-loosening effect.

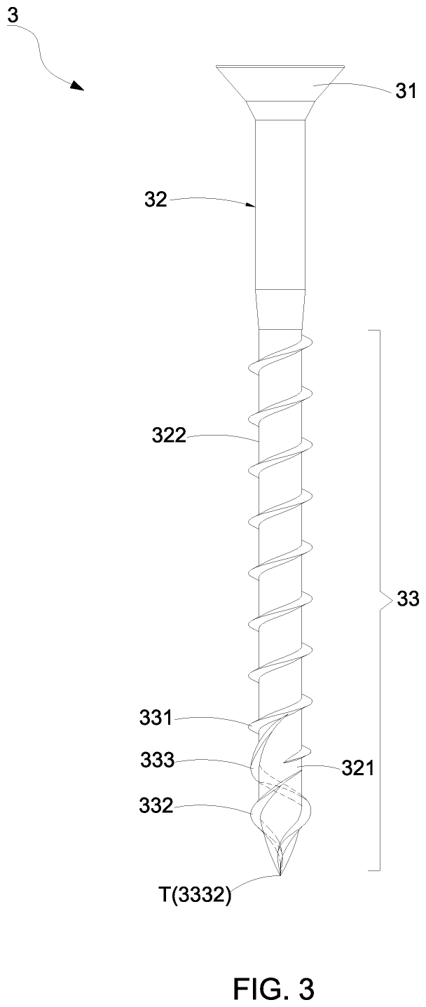

Referring to FIG. 3, a second preferred embodiment of the fastener 3 is shown. Elements, the concatenation of correlated elements, the operation, and effects of the second preferred embodiment are the same as those of the first preferred embodiment and herein are omitted. In the second preferred embodiment, both of the second thread 332 and the third thread 333 spiral from the tip T of the drilling portion 321, respectively. In other words, one end of the second thread 332 and the second end 3332 of the third thread 333 are respectively joined to the tip T, as shown in the figure wherein only the numeral 3332 is indicated at the tip T. Accordingly, the second thread 332 and the third thread 333 drill and cut concurrently at the beginning of the screwing operation and guide the chips from the second thread 332 and the third thread 33 and thence to the first thread 331, thereby decreasing the drilling resistance, attaining a quick drilling and screwing effect, attaining a smooth removal of the chips, preventing the cracking problem of the workpiece, and attaining an anti-loosening effect.

Referring to FIG. 4, a third preferred embodiment of the fastener 3 is shown. Elements, the concatenation of correlated elements, the operation, and effects of the third preferred embodiment are the same as those of the first preferred embodiment and herein are omitted. In the third preferred embodiment, the first thread 331 is extended to the drilling portion 321. Particularly, the first thread 331, the second thread 332, and the third thread 333 spiral from the tip T, respectively. In other words, one end of the first thread 331, one end of the second thread 332 and the second end 3332 of the third thread 333 are respectively joined to the tip T, as shown in the figure wherein only the numeral 3332 is indicated at the tip T. Accordingly, the first thread 331, the second thread 332, and the third thread 333 drill and cut concurrently at the beginning of the screwing operation and guide the chips from the second thread 332 and the third thread 333 and thence to the first thread 331, thereby decreasing the drilling resistance, attaining a quick screwing and drilling effect, attaining a smooth removal of the chips, preventing the cracking problem of the workpiece, and attaining an anti-loosening effect.

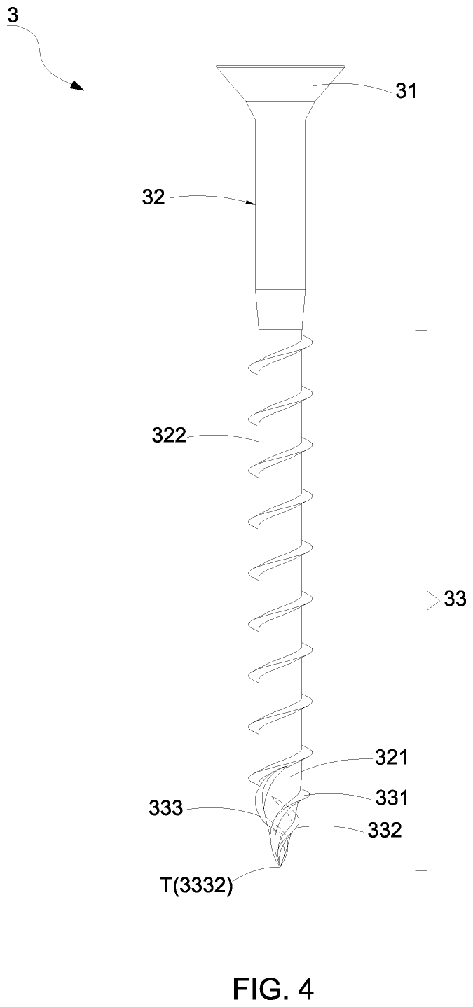

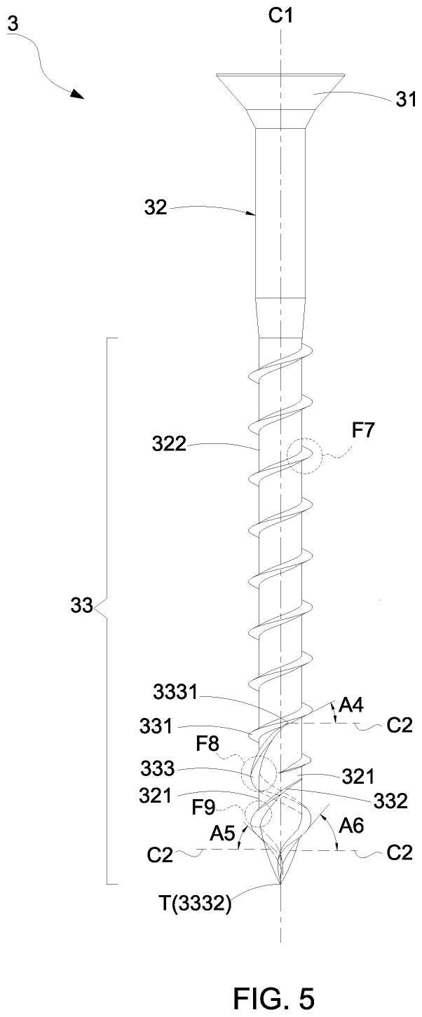

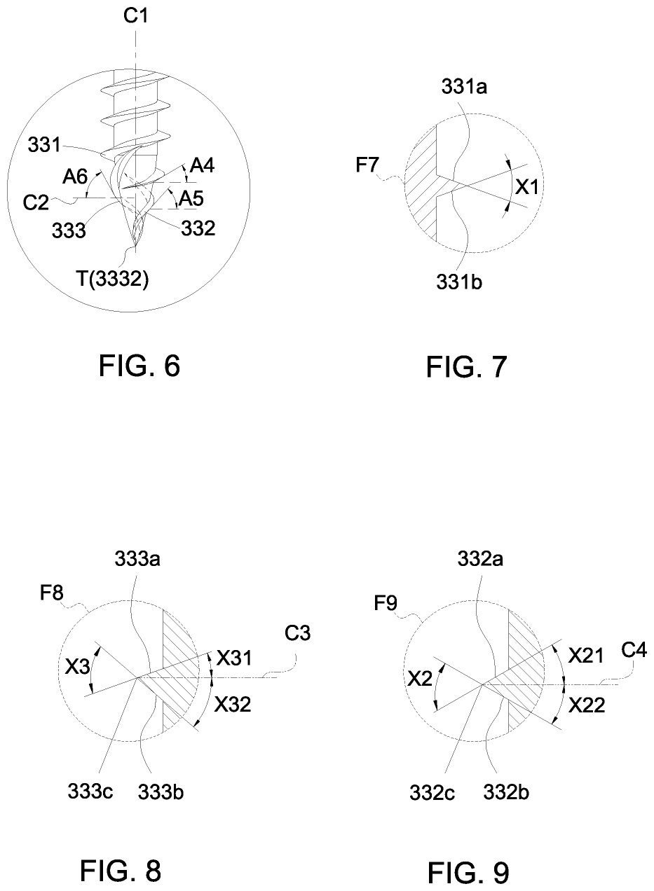

Referring to FIG. 5, a fourth preferred embodiment of the fastener 3 still includes the elements disclosed by the first preferred embodiment, namely the first thread 331, the second thread 332, and the third thread 333 formed between the first thread 331 and the second thread 332. The fourth preferred embodiment is characterized in that the first end 3331 of the third thread 333 is connected to the first thread 331, and the second end 3332 of the third thread 333 is connected to the tip T of the drilling portion 321. The second thread 332 is not connected to the tip T so that a space is defined between the end of the second thread 332 and the tip T. The spiraling directions of the second thread 332 and the third thread 333 are not limited. Especially, the spiraling directions can be adjusted to meet the number of thread convolutions or the spiral angles. For example, the spiral appearance of the threads 332, 333 shown in FIG. 5 is different from the spiral appearance of the threads 332, 333 shown in FIG. 6. Both appearances are still based on the same structure and involved in the same operations and effects.

The shank unit 32 further defines a horizontal reference line C2 perpendicular to the central axis C1. The first thread 331 defines a first path while spirally winding around the shank portion 322, and the second thread 332 and the third thread 333 define a second path and a third path while spirally winding around the drilling portion 321, respectively. Accordingly, a fourth included angle A4 is defined between the horizontal reference line C2 and the first path of the first thread 331, a fifth included angle A5 is defined between the horizontal reference line C2 and the second path of the second thread 332, and a sixth included angle A6 is defined between the horizontal reference line C2 and the third path of the third thread 333. Preferably, the sixth included angle A6 can be greater than the fourth included angle A4, and the sixth included angle A6 can also be greater than the fifth included angle A5. For example, the value of the sixth included angle A6 can be twice the value of the fourth included angle A4, and the value of the sixth included angle A6 can be greater than the value of the fifth included angle A5. In terms of the horizontal reference line C2, the third thread 333 is inclined to a greater extent by comparison with the first thread 331 and the second thread 332, thereby driving the drilling portion 321 into a workpiece easily.

Also referring to FIGS. 7 to 9, the first thread 331 includes a first upper surface 331a facing the head 31 and a first lower surface 331b facing the tip T. The third thread 333 includes a third upper surface 333a facing the head 31 and a third lower surface 333b facing the tip T. The third upper surface 333a and the third lower surface 333b converge at a crest 333c. In other words, the crest 333c is defined along a junction of the third upper surface 333a and the third lower surface 333b. The second thread 332 includes a second upper surface 332a facing the head 31 and a second lower surface 332b facing the tip T. The second upper surface 332a and the second lower surface 332b converge at a peak 332c. In other words, the peak 332c is defined along a junction of the second upper surface 332a and the second lower surface 332b. The crest 333c defines a crest reference line C3 perpendicular to the central axis C1. The peak 332c defines a peak reference line C4 perpendicular to the central axis C1.

A first thread angle X1 is defined between the first upper surface 331a and the first lower surface 331b, as shown in FIG. 7. The first thread angle X1 can be different from a third thread angle X3 which is shown in FIG. 8 and defined between the third upper surface 333a and the third lower surface 333b and can also be different from a second thread angle X2 which is shown in FIG. 9 and defined between the second upper surface 332a and the second lower surface 332b. In the fourth preferred embodiment, the first thread angle X1 is smaller than both of the third thread angle X3 and the second thread angle X2, and the second thread angle X2 is equal to the third thread angle X3. In addition, a third upper thread angle X31 defined between the third upper surface 333a and the crest reference line C3 can be different from a third lower thread angle X32 defined between the third lower surface 333b and the crest reference line C3. Preferably, the third lower thread angle X32 is larger than the third upper thread angle X31, thereby presenting an asymmetrical design (shown in FIG. 8). A second upper thread angle X21 defined between the second upper surface 332a and the peak reference line C4 can be equal to a second lower thread angle X22 defined between the second lower surface 332b and the peak reference line C4, thereby presenting a symmetrical design (as shown in FIG. 9). Accordingly, as for example shown in this preferred embodiment, respective thread angles X2, X3 of the symmetrical second thread 332 and the asymmetrical third thread 333 are the same and are larger than the first thread angle X1 of the first thread 331. The unique combination of the above conditions allows the threads 331, 332, 333 to be quickly driven into a workpiece with smaller drilling resistance and also enhances pull-out force, that is, pull-out resistance whereby the fastener 3 is not easily pulled out of the workpiece.

As mentioned above, the third thread 333 is connected to the tip T and inclined to a greater extent with respect to the horizontal reference line C2. The third thread 333 is also in the form of an asymmetric design. As to the operation of the fourth preferred embodiment, the above features allow the third thread 333 to cut fibers of a workpiece into chips and execute a smooth drilling action, and concurrently the second thread 332 formed on the drilling portion 321 cut the fibers into chips. Thus, the cutting ability and efficiency can be increased, and the drilling resistance can be efficiently decreased for attaining a quick screwing operation. The connection between the third thread 333 and the first thread 331 also allows the chips to travel directly from the third thread 333 to the first thread 331, and the chips are finally removed from the head 31, thereby attaining a quick removal of chips to protect the workpiece from the cracking problem and allowing remaining chips which are not removed from the head 31 to be stored between the shank unit 32 and the workpiece. Accordingly, the fastener 3 can be firmly fastened in position to attain an anti-loosening effect.

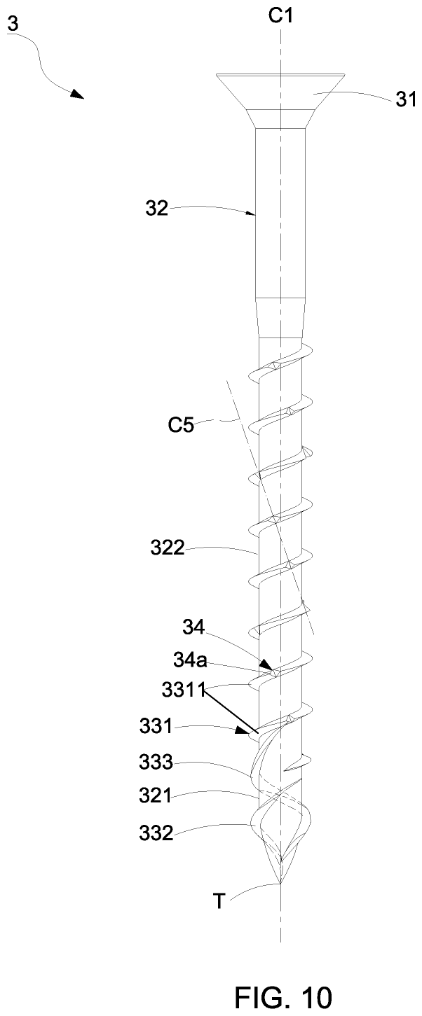

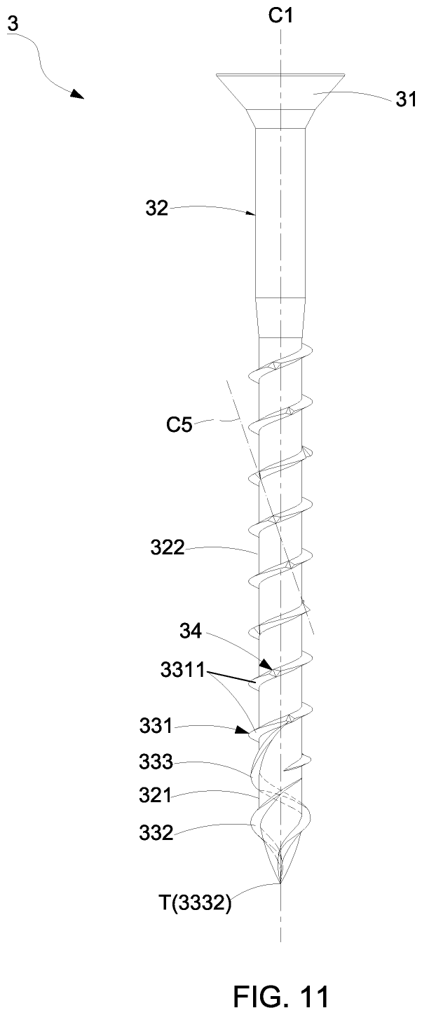

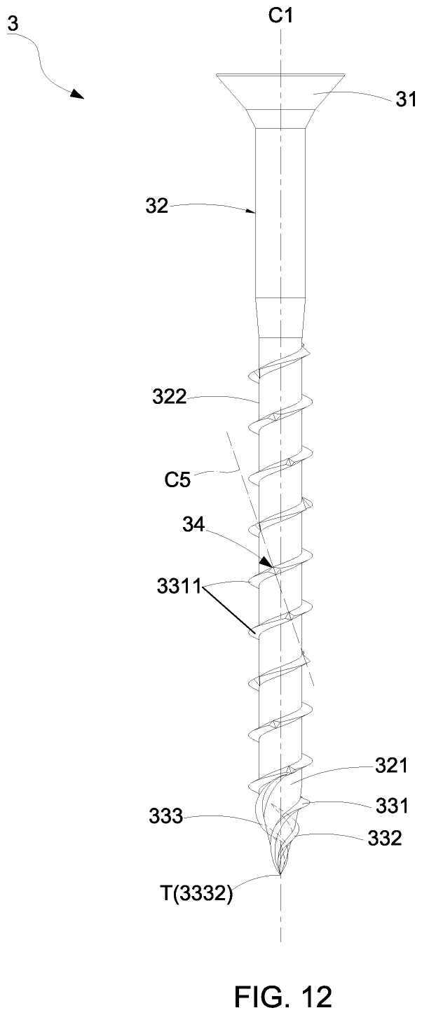

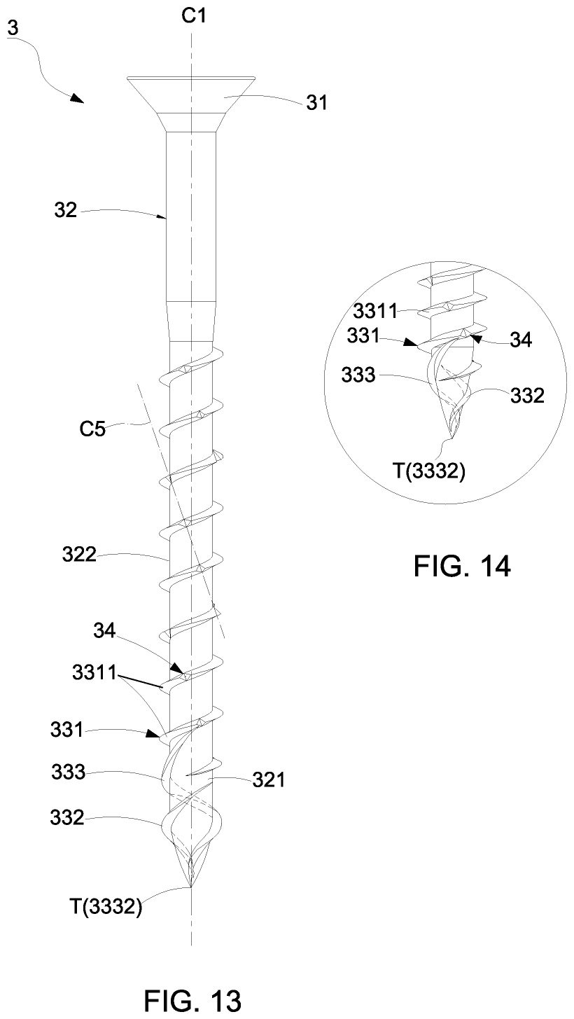

A fifth preferred embodiment of the fastener 3 still includes the elements of the first preferred embodiment, namely the first thread 331, the second thread 332, and the third thread 333 formed between the first thread 331 and the second thread 332. The first thread 331 includes a plurality of first threaded convolutions 3311, and the fifth preferred embodiment is characterized in that a cutting unit 34 is formed on each first threaded convolution 3311. The cutting unit 34 includes at least one cutting notch 34a, and herein it takes an example of two spaced-apart cutting notches 34a recessedly formed in each first threaded convolution 3311. Accordingly, the cutting unit 34 can combine with the structures illustrated by FIG. 1, FIG. 3, and FIG. 4, and the combinations are respectively shown in FIG. 10, FIG. 11 and FIG. 12. The cutting unit 34 can also combine with the structures illustrated by FIG. 5 and FIG. 6, and the combinations are respectively shown in FIG. 13 and FIG. 14. Furthermore, the first thread 331 defines an imaginary line C5. The imaginary line C5 is defined by connecting respective cutting units 34 of adjacent first threaded convolutions 3311 in sequence, and the imaginary line C5 is not parallel to the central axis C1. In other words, an included angle is formed between the imaginary line C5 and the central axis C1 because of the non-parallel arrangement. According to the non-parallel arrangement, the cutting units 34 on the first threaded convolutions 3311 follow a spiral track caused by the drilling of the first threaded convolutions 3311 into a workpiece, thereby cutting the workpiece successively and guiding chips out of the head 31 smoothly for preventing the workpiece from cracking. The cutting units 34 also help decrease the drilling resistance for attaining a quick screw operation and an anti-loosening effect.

To sum up, a first thread, a second thread, and a third thread are respectively disposed on the outer periphery of the shank unit in different spiraling forms winding around the shank portion and the drilling portion. The third thread located between the first thread and the second thread is connected to the first thread and even can be connected to a tip of the drilling portion. Accordingly, this invention takes advantage of different spiraling forms and the connection to the first thread to increase the cutting ability and efficiency, reduce drilling resistance, accelerate the removal of chips, and assist the shank unit in engaging with the workpiece firmly, thereby attaining a quick screwing effect, preventing the workpiece from cracking, and attaining an anti-loosening effect.

While the embodiments are shown and described above, it is understood that further variations and modifications may be made without departing from the scope of this invention.

What is claimed is:

1. A fastener comprising:
a head;
a shank unit extending longitudinally from said head and defining a central axis, wherein said shank unit includes a drilling portion and a shank portion formed between said head and said drilling portion, said drilling portion having a tip located in opposing relationship to said head; and
a thread unit spirally disposed on said shank unit;
wherein said thread unit includes a first thread spirally disposed on an outer periphery of said shank portion and a second thread and a third thread spirally disposed on an outer periphery of said drilling portion, respectively, with said third thread located between said first thread and said second thread, said third thread having a first end facing said head and a second end opposite to said first end, said first end of said third thread being connected to said first thread, said second end of said third thread being connected to said tip of said drilling portion.

2. The fastener according to claim 1, wherein said shank unit defines a horizontal reference line perpendicular to said central axis, said first thread defining a first path while spirally winding around said shank portion, said second thread and said third thread defining a second path and a third path respectively while spirally winding around said drilling portion, a fourth included angle being defined between said horizontal reference line and said first path of said first thread, a fifth included angle being defined between said horizontal reference line and said second path of said second thread, a sixth included angle being defined between said horizontal reference line and said third path of said third thread, said sixth included angle being greater than said fourth included angle.

3. The fastener according to claim 1, wherein said first thread includes a first upper surface facing said head, a first lower surface facing said tip, and a first thread angle defined between said first upper surface and said first lower surface, said third thread including a third upper surface facing said head, a third lower surface facing said tip, and a third thread angle defined between said third upper surface and said third lower surface, said first thread angle being different from said third thread angle.

4. The fastener according to claim 3, wherein said first thread angle is smaller than said third thread angle.

5. The fastener according to claim 1, wherein said third thread includes a third upper surface facing said head and a third lower surface facing said tip, said third upper surface and said third lower surface converging at a crest, said crest defining a crest reference line perpendicular to said central axis, a third upper thread angle defined between said third upper surface and said crest reference line being different from a third lower thread angle defined between said third lower surface and said crest reference line.

6. The fastener according to claim 1, wherein said second thread includes a second upper surface facing said head and a second lower surface facing said tip, said second upper surface and said second lower surface converging at a peak, said peak defining a peak reference line perpendicular to said central axis, a second upper thread angle defined between said second upper surface and said peak reference line being equal to a second lower thread angle defined between said second lower surface and said peak reference line.

7. The fastener according to claim 1, wherein said first thread includes a first upper surface facing said head, a first lower surface facing said tip, and a first thread angle defined between said first upper surface and said first lower surface, said second thread including a second upper surface facing said head, a second lower surface facing said tip, and a second thread angle defined between said second upper surface and said second lower surface, said first thread angle being different from said second thread angle.

8. The fastener according to claim 7, wherein said first thread angle is smaller than said second thread angle.

9. The fastener according to claim 1, wherein said second thread includes a second upper surface facing said head, a second lower surface facing said tip, and a second thread angle defined between said second upper surface and said second lower surface, said third thread including a third upper surface facing said head, a third lower surface facing said tip, and a third thread angle defined between said third upper surface and said third lower surface, said second thread angle being equal to said third thread angle.

10. The fastener according to claim 1, wherein said first thread includes a plurality of first threaded convolutions, a cutting unit being formed on each of said first threaded convolutions.

11. The fastener according to claim 10, wherein said first thread defines an imaginary line, said imaginary line being defined by connecting respective cutting units of adjacent first threaded convolutions sequentially, said imaginary line being non-parallel to said central axis of said shank unit.

12. A fastener comprising:
a head;
a shank unit extending longitudinally from said head and defining a central axis, wherein said shank unit includes a drilling portion and a shank portion formed between said head and said drilling portion, said drilling portion having a tip located in opposing relationship to said head; and
a thread unit spirally disposed on said shank unit;
wherein said thread unit includes a first thread spirally disposed on an outer periphery of said shank portion and a second thread and a third thread spirally disposed on an outer periphery of said drilling portion, respectively, with said third thread located between said first thread and said second thread, said third thread having a first end facing said head and a second end opposite to said first end, with said first end of said third thread connected to said first thread, said first thread defining a first path while spirally winding around said shank portion, said second thread and said third thread defining a second path and a third path respectively while spirally winding around said drilling portion, a first included angle being defined between said central axis and said first path of said first thread, a second included angle being defined between said central axis and said second path of said second thread, a third included angle being defined between said central axis and said third path of said third thread, said first included angle being greater than said third included angle, said third included angle being greater than said second included angle.

13. The fastener according to claim 12, wherein said second thread is connected to said tip so that said second thread starts spiraling from said tip.

14. The fastener according to claim 12, wherein said second end of said third thread is connected to said tip.

15. The fastener according to claim 12, wherein said first thread is connected to said tip so that said first thread starts spiraling from said tip.
